(19) United States
(12) Patent Application Publication
(10) Pub. No.: US 2021/0142143 A1
(43) Pub. Date: May 13, 2021

(54) ARTIFICIAL INTELLIGENCE SYSTEMS AND METHODS

(71) Applicant: Kevin D. Howard, Mesa, AZ (US)

(72) Inventor: Kevin D. Howard, Mesa, AZ (US)

(21) Appl. No.: 17/095,669

(22) Filed: Nov. 11, 2020

Related U.S. Application Data
(60) Provisional application No. 62/933,638, filed on Nov. 11, 2019.

(51) Int. Cl. G06N 3/00; H04W 84/18

(52) U.S. Cl. CPC G06N 3/006; H04W 84/18

(57) ABSTRACT

Systems, methods, and computer programs for providing artificial intelligence from context, artificial emotions, predictive polynomials, and the like. The systems and methods are capable of automatic programming and compute resource allocation. The system can directly interface with humans and any set of devices or sensors that are network accessible. Context is used to decrease the amount of information required from either humans or other systems. The system can learn from other similar systems, other data-generating systems, humans, or raw sensor-detected data streams. The systems and methods use operator-provided goals, received data attributes and values, and the information context to learn and self-modify.

### PRIORITY

This application claims priority to and the benefit of U.S. Provisional Patent Application No. 62/933,638, filed Nov. 11, 2019, which is fully incorporate herein by reference.

### TECHNICAL FIELD

The present invention relates generally to systems, methods, and computer programs for providing artificial intelligence from context, artificial emotions, and predictive polynomials.

### BACKGROUND OF THE INVENTION

Conventional computing systems and processing methods merely focus on “weak” or narrowly defined artificial intelligence (AI). These systems and methods are statistically based and, therefore, require repetition. As a result, the systems can take a great deal of time to train and must incorporate a fixed set of objects or events in order to facilitate learning. This can be inefficient and costly.

As such, there is a need for new and improved computing systems and methods to address these deficiencies.

### SUMMARY OF THE INVENTION

The systems and methods of the present invention provide a “semi-strong” AI capable of self-modification, self-programming, and learning so long as the context of what is to be learned is defined and there are goals to be met.

Semi-strong AI can be considered an intermediate step between weak and strong AI. The difference between the present system and a strong AI system is its lack of self-motivation. The AI of the present invention can include immediate applications in the Internet of Things or any other collection of networked devices, sensors, computers, and humans. Instead of statistics, this system uses received dataset attributes and the information context to learn. Context includes both internal and external context and limits the amount of information that must be passed between devices/sensors and humans. This system is designed with the ability to communicate with various devices and sensors as well as with humans using natural language. Humans provide the goals and requirements for the system.

Goals can have changing real-time aspects. That is, data can be accumulated and processed with varying time frames. In order to change the processing speed to meet varying real-time requirements, a system must be able to vary the number of connected compute resources.

The present invention meets real-time requirements by first automatically decomposing each data-processing algorithm into a set of executable time-affecting linear pathways, identifying the input variable attributes and their value ranges, constructing an input attribute table that relates variable attributes and input dataset values, generating a time-prediction polynomial for each linear pathway within an algorithm, parallelizing the pathways, and identifying the pathways for automatic selection purposes.

The present invention uses emotion analogs to automatically vary the processing resource allocation per time-affecting linear pathway to increase or decrease the processing time across multiple parallel time-affecting linear pathways.

Data objects are automatically identified using temporal and spatial relationships, and the system can automatically predict the behavior of various detected attributes and data objects by creating its own prediction polynomials.

The present invention provides for self-programming and self-modification without the need for human intervention. Goal access can be accomplished, even in the absence of direct goal-activation data, using chains of emotion analogs.

Aspects, methods, processes, systems and embodiments of the present invention are described below with reference to the accompanying drawings.

### BRIEF DESCRIPTION OF THE DRAWINGS

The accompanying drawings, which are incorporated herein and form part of the specification, illustrate various embodiments of the present disclosure and, together with the description, further explain the principles of the disclosure and to enable a person skilled in the pertinent art to make and use the embodiments disclosed herein. In the drawings, like reference numbers indicate identical or functionally similar elements.

FIG. 1 is a diagram of an artificial intelligence system and method, in accordance with embodiments of the present invention.

FIGS. 2-3 show common physical characteristics tables of an artificial intelligence system and method, in accordance with embodiments of the present invention.

FIGS. 4-5 show positional physical characteristics tables of an artificial intelligence system and method, in accordance with embodiments of the present invention.

FIGS. 6-7 show specific physical characteristics tables of an artificial intelligence system and method, in accordance with embodiments of the present invention.

FIGS. 8-9 show logical functions tables of an artificial intelligence system and method, in accordance with embodiments of the present invention.

FIG. 10 shows a functions requirement editor of an artificial intelligence system and method, in accordance with embodiments of the present invention.

FIG. 11 shows the interaction between an operator and the logical functions table of an artificial intelligence system and method, in accordance with embodiments of the present invention.

FIGS. 12-13 show overall context commands tables of an artificial intelligence system and method, in accordance with embodiments of the present invention.

FIG. 14 shows a composite commands table of an artificial intelligence system and method, in accordance with embodiments of the present invention.

FIG. 15 show a displayed map showing a selected target waypoint and drone starting waypoint for an artificial intelligence system and method, in accordance with embodiments of the present invention.

FIGS. 16a-16c show various displayed maps for an artificial intelligence system and method, in accordance with embodiments of the present invention.

FIGS. 17a-17b show various maps and map overlays for an artificial intelligence system and method, in accordance with embodiments of the present invention.

FIG. 18 shows a compute resource status table of an artificial intelligence system and method, in accordance with embodiments of the present invention.

FIG. 19 shows an input attribute to time-affecting linear pathways (TALP) table of an artificial intelligence system and method, in accordance with embodiments of the present invention.

FIGS. 20-24 show various displayed TALP vector (TV) diagrams or graphs of an artificial intelligence system and method, in accordance with embodiments of the present invention.

FIG. 25 shows an intersystem network diagram of an artificial intelligence system and method, in accordance with embodiments of the present invention.

FIG. 26-27 show emotion analogs (Emlogs) and multiple Emlog connectivity of an artificial intelligence system and method, in accordance with embodiments of the present invention.

FIG. 28 shows an Emlog chain diagram of an artificial intelligence system and method, in accordance with embodiments of the present invention.

### DETAILED DESCRIPTION OF PREFERRED EMBODIMENTS

Referring generally to FIGS. 1-28, exemplary aspects of computing systems and methods for AI are provided.

Various devices or computing systems can be included and adapted to process and carry out the aspects, computations, and algorithmic processing of the software systems and methods of the present invention. Computing systems and devices of the present invention may include a processor, which may include one or more microprocessors and/or one or more circuits, such as an application specific integrated circuit (ASIC), field-programmable gate arrays (FPGAs), etc. Further, the devices can include a network interface. The network interface is configured to enable communication with a communication network, other devices and systems, and servers, using a wired and/or wireless connection.

The devices or computing systems may include memory, such as non-transitive, which may include one or more non-volatile storage devices and/or one or more volatile storage devices (e.g., random access memory (RAM)). In instances where the devices include a microprocessor, computer readable program code may be stored in a computer readable medium or memory, such as, but not limited to magnetic media (e.g., a hard disk, solid-state drive, etc.), optical media, memory devices (e.g., random access memory, flash memory), etc. The computer program or software code can be stored on a tangible, or non-transitive, machine-readable medium or memory. In some embodiments, computer readable program code is configured such that when executed by a processor, the code causes the device to perform the steps described above and herein. In other embodiments, the device is configured to perform steps described herein without the need for code.

It will be recognized by one skilled in the art that these operations, algorithms, logic, method steps, routines, sub-routines, and modules may be implemented in software, in firmware, in special purpose digital logic, and any combination thereof without deviating from the spirit and scope of the present invention as recited within the claims attached hereto.

The devices or computing devices may include an input device. The input device is configured to receive an input from either a user (e.g., admin, user, etc.) or a hardware or software component—as disclosed herein in connection with the various user interface or automatic data inputs. Examples of an input device include a keyboard, mouse, microphone, touch screen and software enabling interaction with a touch screen, camera, etc. The devices can also include an output device. Examples of output devices include monitors, televisions, mobile device screens, tablet screens, speakers, remote screens, etc. The output device can be configured to display images, media files, text, or video, or play audio to a user through speaker output.

Server processing systems for use or connected with the systems of the present invention, can include one or more microprocessors, and/or one or more circuits, such as an application specific integrated circuit (ASIC), field-programmable gate arrays (FPGAs), etc. A network interface can be configured to enable communication with a communication network, using a wired and/or wireless connection, including communication with devices or computing devices disclosed herein. Memory can include one or more non-volatile storage devices and/or one or more volatile storage devices (e.g., random access memory (RAM)). In instances where the server system includes a microprocessor, computer readable program code may be stored in a computer readable medium, such as, but not limited to magnetic media (e.g., a hard disk, solid-state drive, etc.), optical media, memory devices, etc.

### INTRODUCTION

The conventional terminology discusses two general types of artificial intelligence (AI): weak and strong. Currently, only weak or narrowly defined AI has been shown and is statistically based, which requires repetition, takes a long time to train, and incorporates a fixed set of objects or events that can be learned. Strong AI would be a general artificial intelligence capable of learning anything humans are capable of learning at at-least human learning rates. To date, strong AI has not been shown. The system of the present invention discloses a third type of AI: semi-strong AI which is capable of either self or assisted learning, self-programming, automatic goal attainment, and can learn as long as the context of what is to be learned is defined and there are goals to be met.

Referring to the system of the present invention 100 as depicted in FIG. 1, semi-strong AI can be considered an intermediate step between weak and strong and has immediate applications in the Internet of Things (IoT) or any other collection of networked devices, sensors, computers, and humans. Instead of statistics, this system 100 uses received data attributes (such as data types, data dimensionality, and data transmission and receipt rate) and the information context to learn. Context limits the amount of information that must be passed between devices/sensors 102 and humans and enhances the ability of a human to communicate with the system. Information context includes both internal 104 and external context 106. Internal context 104 provides information concerning the physical characteristics 104a and capabilities of the devices and sensors 102 connected to the system 100. The external context 106 includes processing theme 106a associated data-processing algorithms 106c, as well maps and map overlays 106b.

The goals and requirements 108 are provided to the system 100 by the operator OP, using a natural-language interface. The system 100 uses the context and the goals to automatically generate the native commands 110 needed by the devices/sensors 102 to achieve each goal/requirement 108. It is possible to automatically construct source code from input data and goals/requirements, and other techniques, methods, and systems, as disclosed in the following patent references: U.S. Pat. No. 9,851,949, and U.S. Patent Publication Nos. 2018/0253285 and 2016/0148102, with each of the disclosures hereby incorporated fully herein by reference.

Like natural systems, goals can have changing real-time aspects. That is, data must be accumulated and processed within a certain time frame. Given that any connected computer's performance is fixed, a system of networked compute resources 118 is needed to ensure that the varying real-time requirements can be met. The present system 100 meets real-time requirements by automatically creating executable time-affecting linear pathways (TALPs) 120 from decomposed algorithms, generating a time-prediction polynomial for each pathway, parallelizing the pathways, and identifying the pathways for selection purposes.

Natural systems have the ability to automatically select which algorithms are needed to process the received data. The present system 100 uses a combination of attached natural-language requirements statements and input dataset attributes to automatically select the correct TALP(s) 120. These TALPs 120 are used along with device/sensor 102 commands and functions by the system 100 to construct new composite commands 111 for each goal/requirement 108 given to the system 100.

In a natural system, the real-time requirement to process a dataset varies with the urgency of the needed results. For example, the time available to predict the behavior of a predator varies with its distance away. The present system 100 uses emotion analogs 122 to automatically vary the processing resource allocation per TALP 120 to increase or decrease the processing time across multiple parallel TALPs 120.

Natural compute systems have the ability to generate algorithms that can predict the behavior of various detected objects. The present system 100 uses the ability to separate data input streams (or stream segments) into a set of monotonic streams, then to use the prediction polynomial generator to predict the object's future position, timing or relative speed, or an object's data transformation, that is, to automatically create data object prediction algorithms.

Thus, it is possible for the system of the present invention 100 to receive a goal and, within the information context, generate a solution or predict some behavior without the need for a human to directly program that capability and without using a statistical model.

### Semi-Strong AI System

### Context

The context of the system 100, provided by the operator OP, defines how and where data is gathered and what algorithms are used to process that data. Internal context 104 defines the functions and commands used by a device/sensor 102 as well as the characteristics of the device/sensor 102. The native functions and commands 110 of any device/sensor 102 are mapped to the system's logical functions. Natural-language associations with functions and commands enhance the human-system interface. The external context 106 defines the environment within which the device/sensor 102 resides. This external environment identifies the overarching processing theme 106a, such as, agriculture, surveillance, land management, and the like, used in the selection of those algorithms needed to process the data. The purpose of context is to limit the amount of information that must be passed between devices/sensors 102 and humans. It also provides the information needed for the system 100 to select the algorithms required to process the data to meet the operator's goals.

### Internal Context

Internal context 104 consists of device/sensor physical characteristics 104a, logical functions and native commands 104b, and overall internal context commands 104c. Information specific to the devices/sensors 102 is used to construct tables that translate the general information to the specific so that humans can direct devices/sensors 102 without needing to learn a multitude of device-specific information.

### Physical Characteristics

There are various types of physical characteristics 104a: common, positional, and specific. Table T1 of FIG. 2 depicts the common physical characteristics for any device/sensor 102, while table T2 of FIG. 3 is an example using a commercial drone. Table T3 of FIG. 4 shows the positional physical characteristics 104a for any device/sensor 102, while table T4 of FIG. 5 is an example using the same commercial drone. The specific physical characteristics 104a for a device/sensor 102 are shown in table T5 of FIG. 6, with the example shown in table T6 of FIG. 7.

### Logical Functions and Native Commands

Each networked device or sensor 102 has a manufacturer-provided set of functions that are used to control the device or sensor 102. Typically, there is not commonality between the function names of different manufacturers, forcing users to learn a different function set and protocol for each manufacturer, even when the actual functionality is the same. Referring back to FIG. 1, the current system 100 uses simple natural-language requirement statements that can be translated, using a set of logical functions, into the native functions of the various devices and sensors 102.

The logical functions 104b represent the translation of the native functions of the devices/sensors 102 into a common function set. At a minimum, each device/sensor 102 has empty logical functions, as shown in table T7 of FIG. 8. However, almost all network-connected devices/sensors 102 have at least a power-on/power-off function.

FIG. 9 shows an example of a moderately complex device's logical functions via a logical functions table T8. There is not necessarily a one-to-one match between logical functions and the native functions. For example, the xxxxxPON logical function translates into an xxxxxCDT logical function followed by PWR ON because xxxxxPON is more general than PWR ON, allowing for a timed device startup where the device does not have that native capability. There might not be a relationship between a logical function and some native function as with the xxxxxCDT logical function creating a software interrupt, which is not a native function. Referring again back to FIG. 1, this is possible because the logical functions are not executed on the device/sensor 102 itself, but on an associated network-connected compute resource 118. General functions are translated into native functions, then transferred from the connected compute resources to the device/sensor 102.

Note that in addition to the expected logical function names and the associated native functions, there are the two additional columns of English-Like Attached Requirements 130 and Associated Variable Questions 132 in the logical functions table T7. These two columns form the primary link between device/sensor functions and commands and humans to enhance communication. When the system 100 is used, an operator gives natural-language statements—the goals or requirements—to be translated into logical functions. Since these functions can contain variables, the system prompts the operator to give or input more information with the associated variable questions.

### Associated Natural-Language Requirements

These natural-language phrases are used to search for logical functions in either lists, tables, or databases of functions. The natural-language phrases can be either written or spoken to the system (e.g., via spoken language or voice/audio inputs). There can be more than one such phrase per logical function, and the number can increase in two ways: direct-phrase addition and missed-phrase addition. Direct-phrase addition entails a human accessing the English-like Attached Requirements column 134 and adding or inputting one or more additional requirements, as shown in FIG. 10, an exemplary functions requirement editor 136 screen. Given a natural-language statement, it is possible for the system 100 to not find an associated logical function. The system can indicate that no associated logical function was found and request that the statement be reworded by the user. If after rewording, the system 100 finds the statement, the first unrecognized statement is added to the list of associated statements. Missed-phrase addition constitutes a type of machine observational learning.

### Associated Variable Questions

Some logical functions have variables such as a timing, position, percentage, size, or rates associated with them. Since the variable values must be filled prior to executing the logical function, the system asks natural-language questions to fill in the values. The expected format of the user response is also provided as part of the question. There is always one question per variable. For drones, examples of associated variable questions are:

“How many seconds should I wait before powering up (xxxxx)?”

“How many feet above waypoints and target points should I fly (xxxxx)?”

“What percentage of maximum speed should the drone fly (xxx)?”

The questions are attached to a particular logical function at the time of creation, but can be changed. Operator-defined requirements can generate multiple logical functions. Since the questions are attached to the logical functions themselves, any compound goal or requirement statement inherits those questions which are asked in the order of occurrence. FIG. 11 depicts an abstracted logical command functions table T9 that provides an example of a machine-human interaction.
Rule 1: Build analogies from human interaction failures and successes to improve the system's ability to interact with humans.

### Overall Internal Context Commands

Part of the internal context of a network of devices/sensors 102 and computing devices is the set of system-specific commands, that is, overall internal context commands that are not native to the devices/sensors 102 but can influence the devices/sensors at a higher level of abstraction. The Overall Context Commands table T10 is structured like the logical functions table T8 and might be blank, as shown in FIG. 12.

As in the logical functions table T7, each command has attached or associated natural-language requirement statements which are used to select the command and questions associated with any command variables used to complete each command.

Commands could be given to the system 100 as overall context commands, logical functions, or natural-language requirement statements. All given commands/functions are translated into device native functions. Programming a device/sensor 102 is accomplished using the overall context commands and logical functions that are then transmitted to any device/sensor 102 within the context, regardless of the device/sensor type.

FIG. 13 shows an example of the overall context of copter-type drones. Unlike in the logical functions table T8, the English-like Attached Requirements column 138 in the Overall Context Command table T11 might be N/A because not all of these commands are directly human accessible.

### Composite Commands

The simple natural-language requirement statements attached to logical functions and those overall context commands that are operator accessible can be combined into more complex commands. A requirement statement containing multiple logical functions and/or commands is called a composite command and stored in the Composite Command table T12 of FIG. 14.

### Example of Composite Command Creation

For the drone context, this example creates the HOVER RETURN composite command which causes a drone to travel from its current position to a selected waypoint, hover over the selected waypoint for TBD seconds and then return to the initial position. The Logical Functions and Overall Context Commands tables (T7, T10) are used. The selected target waypoint and drone starting waypoint are shown or displayed on the map of FIG. 15.

Right-clicking or otherwise selecting the starting waypoint causes a Requirements box 140 to appear or display. The operator then enters a natural-language requirement. The following composite requirement is analyzed to produce a set of functions and commands found in the tables:

Given: “Fly to the next target, hover, then return.”→FW, xxxxH, FWR

“Fly to the next target”→FW (From the Logical Functions table)

“hover”→xxxxH (From the Logical Functions table)

“then return.”→FWR (From the Overall Context Commands table)

In this example, the operator selected a starting waypoint on the map which gave location information to the system 100 and then entered a requirement which caused two logical functions to be generated for the starting location (FW, xxxxH) and one command for the target location (FWR). Using the composite definition command (CD), a new composite command is created by the system 100, named Hover Return by the operator, and stored in the Composite Commands CC table. The next time the statement “Fly to the next target then return” is given, only the Hover Return composite command is found and used.
Rule 2: A system, given natural-language requirements by an operator, can automatically find multiple lower-level commands and associate them.

### External Context

The external context 106 consists of maps and any associated map overlays 106b of the external environment. The maps and overlays allow a device/sensor 102 to be oriented and reconciled with activity external to device/sensor 102, such as, weather, special events, location of network resources, and the like. External context 106 can also include the overarching theme 106a, such as agriculture, surveillance, or land management, and the previously associated and prioritized algorithms needed to process the data to meet an operator-provided goal.

Maps can be topographic, image-based, architectural, or any other type of map as long as it is geo-registered on all levels. FIGS. 16a-16c show various types of maps M1, M2, M3. FIGS. 17a-17b show various types of map overlays MO. The information from the overlays is combined with internal context information to determine the feasibility of a goal or requirement. For example, a drone with a maximum wind resistance of 15 miles per hour cannot fly in the zone designated in the weather activity rectangle of the weather overlay because of its 20 miles per hour winds. Other metrics and information can be used to determine feasibility of a goal or requirement as well.

### Compute Resources and Data Processing

Network-associated compute resources 118 can be mobile (phones, laptop computers, tablets, etc.) or fixed (desktop computers, servers, etc.). Referring to the compute resource status table T13 of FIG. 18, devices/sensors periodically send status and data to at least one external compute resource on the network, and this information can be shared among all compute resources on the network. Compute resources can also send status and data such as cores per processor allocation, physical position, memory usage, device/sensor direct association, data channel allocation, and any executable applications to other networked compute resources. Compute resource information is used to select the available resources used by the system 100.

Relevant internal context/information about the characteristics, functions, and commands of devices/sensors and relevant external context is uploaded at system startup. Associated data-processing algorithms that have been uploaded to the system are automatically parallelized. Advanced automated parallelization ensures that varying real-time requirements are met, that is, data is accumulated and processed within a given time frame.

In order to automatically parallelize an algorithm, it is first automatically decomposed by the system, creating a set of one or more TALPs. Each TALP has attached natural-language requirement statements obtained from the header of the originating algorithm and an operator-provided text string identifying the external context overarching theme. This identifying information, along with the input data values and types, is applied to the available TALPs to determine which TALP is selected to meet the operator's requirement. A time-prediction polynomial is generated and saved for every parallelized TALP.

### Meeting Varying Real Time Requirements

The system 100 meets the varying real-time requirements set by humans or by automatically received data rates:

1. Decomposing each human-provided data-processing algorithm into a set of executable TALPs.

2. Identifying the initial non-loop-control input attribute values (which do not affect time) that are used in the algorithm's IF-THEN-ELSE statements and constructing an Input Attribute to TALP table that relates those attributes and their values with specific TALPs.

3. Using the initial loop-control input attributes values (which affect time) to generate a time-prediction polynomial for every TALP of every algorithm used by the system 100.

4. Using the time-prediction polynomial to parallelize the TALPs.

The system decomposes an algorithm into a set of TALPs and relates non-loop-control input attribute values to particular TALPs. As shown in FIG. 19, an Input Attribute to TALP table T14, containing the operator-provided external context text string, various algorithm indexes, TALP indexes, TALP input attribute names, types (such as int, double, Boolean, string), minimum, and maximum values, and natural-language requirement statements, is generated.

The minimum and maximum values constitute the acceptable value range of the attributes of the TALP.

After a time-prediction polynomial is found for each TALP, all TALPs are parallelized. TALPs are compiled and available for execution on compute resources. Based on the input data attributes and comparison of these attributes to the IAT table, the current system 100 automatically selects the appropriate TALP, with its associated time-complexity polynomial, to analyze the data. Being able to automatically select the TALP required to process some data stream is a form of autonomous processing. Incoming data is automatically spread over multiple compute resources using various techniques, including those disclosed in the patent references incorporated by reference herein. The first compute resource to receive a request to execute a parallel TALP becomes the parallel computing operations controller. Knowing how many compute resources to allocate for a given TALP, and the method for allocation, is discussed below after artificial emotions.

### Artificial Emotions

Natural compute systems seem to have an emotional component to them. For the computational process, this emotional component has been considered at best unnecessary and at worst detrimental. Since emotional traits can be traced through all animals with central nervous systems, emotion-based environmental analysis, computation, and response must offer very strong survival and adaptation characteristics.

Natural compute systems must interact directly with a chaotic natural environment, where a poor and/or untimely solution might be catastrophic to the existence of the natural system. This interaction requires processing multiple input data streams and simultaneously responding with multiple output data streams, while prioritizing, coordinating, and optimizing those responses. Many of the input data streams require real-time processing with rapidly changing priorities. Natural computational elements must be dynamically reallocated very quickly while providing enough computation capability to preform analysis.

Because natural compute systems must rapidly learn their environment, systems that are most able to respond quickly to environmental changes have a competitive advantage over slower adapting systems. With natural compute systems, inputs, outputs, actuators, sensors, and processor resources must be linked together with both minimum calculation and a minimum of repetition. The best systems would have the ability to perform this linkage with a single trial.

Using emotion-like constructs to perform gross-level computational resource allocation offers a model that can perform rapid resource allocation, offer rapid learning methods, and provide a central system focus even though the computational components are distributed, while meeting ever-changing real-time processing requirements.

Statistically based learning systems, such as Bayesian Belief Networks or Support Vector Machines, and even Neural Networks, require both repetition and full network access to generate a learned response and, thus, take time to learn. Such systems incorporate a fixed set of objects or events to which the learning method is applied.

Expert and genetic programming systems, which are not statistically based, still rely on either a fixed set of rules or a rule permutation methodology. This means that, like statistically based systems, they cannot adapt to truly novel events, novel meaning outside of both the rules and any permutation of the rules programmed into the system.

Since Bayesian networks are defined only for directed acyclic graphs (DAG), they have a further limitation: they cannot be used where cycles occur. Cycles occur frequently in natural environments. To get around the DAG limitation, the dependency network model of inference was invented. Though the DAG limitation is eliminated, the a priori event knowledge limitation still exists. In fact, there are no provisions to change either the model or the priors based upon observed data. Fuzzy logic dynamic models are constructed very similarly to A. N. Kolmogorov's set-theoretic definition of probability-based models and suffer from the same a priori event knowledge problem.

Since most of these systems use what is called batch learning, below is the gradient descent algorithm for the simple case of a single neuron classifier. Note that the learning rate given by O(X(n)) is very slow. For each input/target pair (x⁽ⁿ⁾, t⁽ⁿ⁾) (n=1, . . . , N):

### Equation 1. Single Neuron Classifier, Batch Learning Gradient Descent Algorithm

y(x;w)=y(X⁽ⁿ⁾;W)

Because the network models do not change with observed data, the logical/mathematical framework stays the same. This means that if the rate of observed data acquisition changes, the rate of processing still remains fixed. Thus, this type of system does not adapt to something as basic as data rate, so either higher than required performance is given, consuming too many compute resources, or lower than required performance is given, meaning that any associated real-time requirement is left unmet. A machine analog to emotions can be used to dynamically allocate and de-allocate compute resources as required to meet the timing requirements of the highest priority events.

### Emotions as a Resource Allocation Method

Emotions are related to activity in brain areas that direct our attention and memory, motivate our behavior, and determine the significance of what is going on around us. These brain activities can be put into a computational framework.

1. Direct our attention: Allocate sensor and computational resources to a given problem, equivalent to run-time, real-time scheduling in computer systems.

2. Direct our memory: Decide what data is to be retained, equivalent to the data filtering and data storage capabilities found in computer models such as Structured Query Language, SQL, database systems or band pass filters in electronics.

3. Motivate our behavior: Process data such that the prerequisites are met for various system requirements.

4. Determine the significance of what is going on around us: Prioritize the processing of the algorithms used by the system, granting some additional CPU time and others less CPU time.

A computational resource allocation and prioritization scheme needed to best meet the processing timing requirements of multiple, interacting, dynamically changing compute jobs represented by TALPs is called an emotion analog, an Emlog, in the system 100 of the present invention.

### Emotional Resource Allocation Response Example Story

A fictional story can illustrate the relationship between a group of emotions and a group of computationally required sensor and resource allocations, that is, the uses of emotional states to select and schedule algorithms and generate real-time responses needed to process the input stimuli and meet the system's requirements. A range of emotions can be identified, corresponding to algorithm selection, timing requirement generation, and computational resource allocation.

### Emotion 1: Calm, Hungry

An elk in a valley feels hunger, and there are no other overriding requirements. Computational resource allocation can be: 80% to eating, 15% to general observation of environment, 5% to general physical activity.

### Emotion 2: Wary, Hungry

The elk sees something in the distance. Computational resource allocation: 65% to eating, 15% to general observing of environment, 10% to threat analysis, 10% to general physical activity (increased head/eye, ear movement).

### Emotion 3: Concern, Hungry

The elk identifies an object as a threat. Computational resource allocation: 40% to eating, 20% to general observing, 20% threat analysis, 15% to general physical activity, 5% to preparation for flight or fight response.

### Emotion 4: Fear (Hunger Overridden)

The threat is within strike range and appears to be hunting. Computational resource allocation: 0% to eating, 20% to general observing, 20% to threat analysis, 15% to general physical activity, 45% to preparation for flight or fight response.

### Emotion 5: Terror (Hunger Overridden)

The threat attacks; elk chooses flight. Computational resource allocation: 0% to eating, 0% to general observing, 0% to threat analysis, 0% to general physical activity, 0% to prepare for threat activity, 100% to threat evasion.

### Emotion 6: Calm, Tired, Thirsty (Hunger Overridden)

The threat is gone. Computational resource allocation: 55% to resting, 15% to general observing, 25% to seeking water, 5% to general physical activity.

### Time-Affecting Linear Pathway (TALP) Vector for Resource Allocation

It is possible to generate a time-prediction polynomial for each of multiple attributes associated with a TALP, given a set of time-affecting input variable attribute values, w₁. The timings used to generate the time-prediction polynomial and the polynomial itself are saved per attribute per TALP per algorithm.

$$Equation 2. Multiple Attribut e Time - complexity for Minimum Processing Time with n Processing Elements$$

$${T}_{TALP} ( {w}_{1} , n ) \times tu = ( {t}_{{s}_{n}} + {T}_{TALP , p} ( \frac{\frac{{w}_{1}}{{w}_{min}}}{n} ) ) \times {t}_{min} \times tu = {t}_{n} \times tu$$

$$Where : {t}_{{s}_{n}} = fixed time value , \\ {w}_{1} = set of workload ( time affecting variable ) attribute maximum values$$

$${w}_{min} = set of workload attribute minimum values$$

$$n = \# of processing elements the workload attribute maximum values are split across$$

$${t}_{min} = minimum detected processing time while making {T}_{TALP , p} ( )$$

$${T}_{TALP , p} ( ) = multiple attribute time complexity function , \\ {t}_{n} = processing time for n processing elements$$

$$tu = time units$$

It is clear that for each algorithm processed, natural systems utilize a very large number of processing elements. A TALP Vector (TV) represents a parallelized TALP's ability to allocate and deallocate processing elements (PEs) and is a visual graph showing all relevant timing and allocation position information. For each TALP in an algorithm, a TV indicates the current number of PEs allocated to that TALP—the current resource allocation position (CRP)—as well as the minimum and maximum number of PEs needed to meet the timing requirement. Some input data processing is more important than others. For example, the processing related to a submarine's relative or actual depth is frequently more important than processing for its position as the submarine's viability can be directly related to its relative or actual depth and secondarily to its position.

The TV diagram or graph 150 in FIG. 20 relates the time-affecting input attribute values of the TALP to a varying number of PEs, each giving a processing time for that TALP per the multiple-attribute time-complexity polynomial. The symbols of FIG. 20 mean the following:

1. Number of nodes: the number of PEs needed by the current TALP to process the current dataset in the associated processing time.

2. Min resource use: the minimum number of PEs required to process the current dataset in the maximum acceptable processing time.

3. Current resource position indicator: the currently selected number of PEs used by the current TALP to process the current dataset.

4. Max resource use: the maximum possible number of PEs that can be used by the current TALP with the current dataset.

5. Priority number: an operator-entered value. The larger the number, the higher the priority. This number is used in resource allocation when there are multiple TALPs and insufficient compute resources.

6. Processing time: the predicted processing time for the current TALP using some indicated number of PEs for the current dataset.

7. TV index value: the position of the current resource position indicator.

8. TALP name: the name of the decomposed algorithm from which the TALP is generated (or the symbol AUTOxxxxx if a TALP created from a prediction polynomial, discussed below, is generated) followed by a dash and the selected TALP's order of creation.

9. Multiple-attribute time-complexity function: a time-complexity function used to predict the processing time of the current TALPs to process w₁ given various PEs.

Referring to the diagram 152 of FIG. 21, TVs can also be displayed using a TV number to indicate the algorithm, TALP, and multiple-attribute time-complexity function. When the TV graph is displayed, the operator double left-clicking on the TV number causes the algorithm name, TALP name, and the multiple-attribute time-complexity function to be displayed as in FIG. 21. The operator double left-clicking on the algorithm name, TALP name, or multiple-attribute time-complexity function on FIG. 20 causes FIG. 21 to be displayed.

The operator-given requirement is compared against the requirements associated with the TALPs, similar to how logical functions are selected, giving a set of possible TALPs from which the desired TALP is selected. The TALP has a set of input attribute values that do not affect time, the non-loop-control attributes, used by the system to automatically search through the possible TALPs to select the correct TALP to meet the operator requirement needs.

$$Equation 3. Automatic TALP Selection Given Non - Loop - Control TALP attributes$$

$${T}_{i} = select ( C [ i ] [ j ] ) = select ( \{ \begin{matrix}( {a}_{1 , 1} ) , ( {a}_{1 , 2} ) , … ( {a}_{1 , j} ) \\ ( {a}_{2 , 1} ) , ( {a}_{2 , 2} ) , … ( {a}_{2 , j} ) \\ … , \\ ( {a}_{i , 1} ) , ( {a}_{i , 2} ) , … ( {a}_{i , j} )\end{matrix} \} )$$

$$\begin{matrix} Where : {a}_{i , j} = input variable attribute \\ {T}_{i} = index to the current algorithm and TALP \\ j = input variable attribute index value \\ C = set of non - loop - control attributes\end{matrix}$$

Once the correct TALP for a requirement and dataset is selected, its time-prediction polynomial is used with the input dataset to predict processing times given varying numbers of processing elements (PEs). The minimum processing time possible for that dataset becomes the maximum PE count boundary. The maximum processing time possible becomes the minimum PE count boundary. Requests for PEs from multiple TALPs that have been selected for multiple input data streams require the simultaneous allocation of sufficient PEs to meet all real-time requirements.

In a system of allocable resources, it is possible that there are not enough PEs to fulfill the possible PE requests. This is indicated by the dashing of the position indication bar and dashing the current resource position indicator as shown in the diagram 154 of FIG. 22.

The set of time-affecting loop-control input attribute values, w₁, is used by the system 100 to determine a TALP's maximum theoretical number of PEs, n_{x,max}.

$$Equation 4. Maximum Number of Processing Elements for a TALP Given {w}_{1} and {w}_{n}$$

$${n}_{x , max} = min ( \frac{{w}_{1} [ v ] [ a ] [ x \}}{{w}_{n} [ v ] [ a ] [ x ]} ) = min \{ \begin{matrix}\{ \{ \frac{{w}_{1} [ 1 ] [ 1 ] [ 1 ]}{{w}_{n} [ 1 ] [ 1 ] [ 1 ]} , \frac{{w}_{1} [ 1 ] [ 2 ] [ 1 ]}{{w}_{n} [ 1 ] [ 2 ] [ 1 ]} , ⋯ , \frac{{w}_{1} [ 1 ] [ a ] [ 1 ]}{{w}_{n} [ 1 ] [ a ] [ 1 ]} \} , \{ \frac{{w}_{1} [ 2 ] [ 1 ] [ 1 ]}{{w}_{n} [ 2 ] [ 1 ] [ 1 ]} , \frac{{w}_{1} [ 2 ] [ 2 ] [ 1 ]}{{w}_{n} [ 2 ] [ 2 ] [ 1 ]} , ⋯ \frac{{w}_{1} [ 2 ] [ a ] [ 1 ]}{{w}_{n} [ 2 ] [ a ] [ 1 ]} \} , ⋯ , \{ \frac{{w}_{1} [ v ] [ 1 ] [ 1 ]}{{w}_{n} [ v ] [ 1 ] [ 1 ]} , \frac{{w}_{1} [ v ] [ 2 ] [ 1 ]}{{w}_{n} [ v ] [ 2 ] [ 1 ]} , ⋯ , \frac{{w}_{1} [ v ] [ a ] [ 1 ]}{{w}_{n} [ v ] [ a ] [ 1 ]} \} \} , \\ \{ \{ \frac{{w}_{1} [ 1 ] [ 1 ] [ 2 ]}{{w}_{n} [ 1 ] [ 1 ] [ 2 ]} , \frac{{w}_{1} [ 1 ] [ 2 ] [ 2 ]}{{w}_{n} [ 1 ] [ 2 ] [ 2 ]} , ⋯ , \frac{{w}_{1} [ 1 ] [ a ] [ 2 ]}{{w}_{n} [ 1 ] [ a ] [ 2 ]} \} , \{ \frac{{w}_{1} [ 2 ] [ 1 ] [ 2 ]}{{w}_{n} [ 2 ] [ 1 ] [ 2 ]} , \frac{{w}_{1} [ 2 ] [ 2 ] [ 2 ]}{{w}_{n} [ 2 ] [ 2 ] [ 2 ]} , ⋯ \frac{{w}_{1} [ 2 ] [ a ] [ 2 ]}{{w}_{n} [ 2 ] [ a ] [ 2 ]} \} , ⋯ , \{ \frac{{w}_{1} [ v ] [ 1 ] [ 2 ]}{{w}_{n} [ v ] [ 1 ] [ 2 ]} , \frac{{w}_{1} [ v ] [ 2 ] [ 2 ]}{{w}_{n} [ v ] [ 2 ] [ 2 ]} , ⋯ , \frac{{w}_{1} [ v ] [ a ] [ 2 ]}{{w}_{n} [ v ] [ a ] [ 2 ]} \} \} , \\ \{ \{ \frac{{w}_{1} [ 1 ] [ 1 ] [ i ]}{{w}_{n} [ 1 ] [ 1 ] [ i ]} , \frac{{w}_{1} [ 1 ] [ 2 ] [ i ]}{{w}_{n} [ 1 ] [ 2 ] [ i ]} , ⋯ , \frac{{w}_{1} [ 1 ] [ a ] [ i ]}{{w}_{n} [ 1 ] [ a ] [ i ]} \} , \{ \frac{{w}_{1} [ 2 ] [ 1 ] [ i ]}{{w}_{n} [ 2 ] [ 1 ] [ i ]} , \frac{{w}_{1} [ 2 ] [ 2 ] [ i ]}{{w}_{n} [ 2 ] [ 2 ] [ i ]} , ⋯ \frac{{w}_{1} [ 2 ] [ a ] [ i ]}{{w}_{n} [ 2 ] [ a ] [ i ]} \} , ⋯ , \{ \frac{{w}_{1} [ v ] [ 1 ] [ i ]}{{w}_{n} [ v ] [ 1 ] [ i ]} , \frac{{w}_{1} [ v ] [ 2 ] [ i ]}{{w}_{n} [ v ] [ 2 ] [ i ]} , ⋯ , \frac{{w}_{1} [ v ] [ a ] [ i ]}{{w}_{n} [ v ] [ a ] [ i ]} \} \}\end{matrix} \}$$

### Real-time Requirements and TALP Vectors

An industry standard definition of “real time” comes from the POSIX Standard 1003.1b which defines real-time for an operating system as “the ability of the operating system to provide a required level of service in a bounded response time.” This definition is extended here by replacing “operating system” with “TALP running on one or more PEs” and “service” with “processing speed,” giving the following definition of real time.
Rule 3: Real time for a TALP Vector is the ability of a TALP, running on one or more processing elements, to provide the required level of processing performance needed to meet a bounded response time.

The receipt of contiguous datasets for the same TALP represents a queue of datasets. The rate at which the datasets are queued is represented by X in Little's Result. To ensure real time for this queue of datasets means meeting Little's Result.

### Equation 5. Little's Result

N=λT
Where: N=# of queued input events
   λ=average event arrival rate
   T=average time to process an event

This means that as long as T≤N/λ then no queue is formed. Thus, the selection of a processing element count must meet or exceed the N/λ timing criteria. Automatically meeting the real-time requirements is the same as ensuring that no queue is formed.

### Multiple TALP Vectors as a Single Emlog

Referring to the diagram 156 of FIG. 23, in a natural system, multiple algorithms can process different data streams simultaneously. Multiple TALPs, each with its TALP Vector (TV) representation, are selected to process different simultaneous data objects and streams and can be connected using a single control PE, acting as a single entity, called an emotion analog or Emlog. Since each Emlog consists of multiple TALPs, the input attributes of the TALPs are used to create a set of additional TALPs to monitor the data environment. Emlogs are automatically created by the system and stored in a separate database from TALPs The activation of multiple simultaneous TALPs means that an Emlog is capable of performing the equivalent of task-level parallel processing.

The controller in this current system is not a specific PE. It is instead the first free PE accessed to process some set of data. This allows ad hoc networks to participate in the parallel processing required for a TV to meet a given time requirement.

The operator-given requirements and the set of non-loop-control input attribute values is used by the system to search for a matching set of identical attribute values associated with an Emlog. If a matching set is found, the associated Emlog is selected. If no Emlog match is found, the system 100 searches the TALP database for TALPs with attributes that match some or all of the input attribute values. If the found TALPs' prediction polynomials (discussed below) have error margins less than the maximum acceptable error margins, those TALPs are saved and the attributes from the found TALPs are removed from the input attribute list. The system 100 then searches the TALP database using the smaller list of input attribute values. This is continued until there are either no input attributes left or no TALP that matches the attributes that are left. The set of found TALPs becomes the new Emlog and is stored in the Emlog database. If no matching TALPs are found, the system transitions to the error-defining Emlog, made of error-defining TALPS, which displays error messages to the operator and logs the error into the error file.

Emlogs, because of their predictive capabilities, enable the system to change its logical or physical behavior. In computer science, a self-modifying algorithm is one that alters all or part of itself. By extension, a self-modifying system like this is one that alters all or part of itself.
Rule 4: System behavior can be said to be self-modifying if all or part of the system's behavior modifies the behavior of all or part of that same system.
Rule 5: A self-modifying behavior is a self-aware behavior if the modification is directed toward reaching or furthering progress toward some internally defined goal.

Tests of machine thinking include the famous Turing test, the limitations placed on finite state machines given by Godel's theorem, and the Lovelace objection. Given “thought as some extent of reasoning, remembering experiences, making rational decisions,” a derived definition follows: “thinking is the ability to have ideas and to infer new ideas from old ones.”

Any manmade system that exhibits self-modifying and self-aware behavior can be said to be modeling the human thinking process. To remember means to retain a mental impression, which is another way of stating that a mental model is constructed and accessed during thought. A working definition of machine thinking follows.
Rule 6: Any compute system in the act of modifying its internal world model without intervention from another, outside system is defined to be thinking.

If a man-made system creates a new Emlog to help it better deal with the world (to better meet its real-time requirements or select the tools required to analyze a new data stream), then it can reasonably be said to be analogous to thinking.

By replacing “modifying its internal world model” with “creating an Emlog,” a more focused definition of machine thinking follows.
Rule 7: Any compute system in the act of creating an Emlog without intervention by another, outside system is defined to be thinking.

### Monitoring TALPs

Referring to the diagram 158 of FIG. 24, within an Emlog, a TALP that processes data to determine if the Emlog is still valid for an entire data stream as it is being received is said to be monitoring or measuring and is called a monitoring TALP. All Emlogs contain at least a Data monitoring TALP that is used to ensure the validity of the current Emlog. Data monitoring TALPs respond if either the input data rates or the input attributes change. Being able to verify the correctness of the selected Emlog as data changes is a type of machine self-awareness. Other types of monitoring TALPs include Distress Level, Intersystem Communication, and Context. All monitoring TALPs have a higher level of priority than non-monitoring TALPs.

### Data Monitoring TALPs

There are four types of Data monitoring TALPs: Rate, Trigger, Pushdown, and Popup. Rate TALPs verify that the processing performance of the Emlog matches the rate at which input data is received. Trigger TALPs determine that there is enough input data to activate the non-monitoring TALPs of the current Emlog. Pushdown TALPs, in response to a non-Data monitoring TALP, push the current input data and the currently active TALPs of the Emlog in the Emlog chain onto a pushdown stack then stops sending data to the non-monitoring TALPs. Popup TALPs restore the pushed down input data and TALPs then starts sending data to the non-monitoring TALPs of the current Emlog. Popup TALPs, also in response to a non-Data monitoring TALP, restore the processing TALPs and the pushed down data that occurred prior to the pushdown then start sending data to the non-monitoring TALPs of the current Emlog. Invoking a Popup TALP without stack data is considered non-actionable.

### Distress Level Monitoring TALPs

Distress Level monitoring TALPs determine if the system is under attack and must have a greater priority than other monitoring TALPs because it ensures the viability of the system. For example, system sensor detecting an unscheduled data object that will intercept the position of the current system requires a system response. The Distress Level monitoring TALP determines the object's type, approach vector, and velocity. That information enables the system to generate a response time-window. The response could range from positional movement to the triggering of an offensive capability. This is similar to the emotions of fear or anger in a natural system and could be important to systems in the field. If there is a monitoring TALP that determines that one (or more) data object(s) is approaching the location of devices/sensors that are part of the system, then the maximum detected velocity of the approaching data object could determine how soon the data object will intersect system or cross some distance threshold.

Prior to crossing the distance threshold when action must be taken, the number of compute resources used by this type of monitoring TALP increases while the detected approaching data object distance decreases. Increasing the monitoring of approaching data objects corresponds to wariness by the system. Crossing the distance threshold could then elicit a fight (if there is some system-associated offensive capability) or flight (if the devices/sensors are mobile) response. Either fight or flight mode causes some or all of the tasks being performed by the system to be suspended until the problem is averted. Taking a fight or flight action corresponds to fear.

To perform the fight or flight response the system first activates the Pushdown TALP to stop the current processing, followed by activating the Trigger TALP to perform the fight or flight response. Once the fight or flight response is no longer needed the Distress TALP activates the Popup TALP to restore the prior processing.

A Distress Level monitoring TALP that determines when it is time to return to base for refueling/recharging for some or all of the devices/sensors corresponds to hunger.

### Intersystem Communication Monitoring TALPs

A system is a network of devices/sensors, compute resources, and operators. When another system is detected, it is possible for Emlog of one system 170 to attempt to communicate an Emlog in the other system 172. It is possible for multiple systems to safely communicate via the intersystem network, as depicted in the diagram 160 of FIG. 25. Given that the intersystem network is an ad hoc network 174, logins are not required. The systems can now trade or communicate authentication information. Once authenticated, depending on the level of authentication, data, TVs and/or Emlogs can be shared. Once any sharing is complete, the ad hoc network can be abandoned.

Many Emlogs contain an Intersystem Communication monitoring TALP that continuously scans for other system authentications and requests. There are either zero or two Intersystem Communication monitoring TALPs: Send and Receive. The Send TALP can send, and the receive TALP can receive, data, TALPs, Emlogs, and/or Emlog chains for processing.

### Context Monitoring TALPs

Since the Input Attributes to TALPs table requires the general external context, if this context changes then all of the accessed TALPs become unusable. New TALPs associated with context-relevant Emlogs are accessed for processing the various input data attribute values. The ability to automatically and rapidly adjust processing based on changing context represents a capability that remains rare in man-made systems.

### Machine Learning and Current Resource Position Movement

The basis for time-related machine learning in this system 100 is the manipulation of the current resource position (CRP) in a TALP Vector (TV) based on the input attribute data rate. Two types of CRP movement issues exist: insufficient PE count for the minimum allocation requirement and insufficient maximum CRP indicated, that is, the need for a greater number of PEs than be used as the maximum.

### Insufficient Processing Elements for the TV Resource Allocation

When an Emlog is selected in response to data inputs, insufficient PEs to meet the minimum real-time performance requirement or a data packet rate that exceeds the real-time processing capabilities of the TV requires additional nodes to be obtained. Since each TV has a priority from its associated algorithm, the priority of the current TV is compared against the priorities of all other TVs by the Rate monitoring TALP within the current Emlog. If one, or more TVs, has a lower priority than the current TV then the CRP value of each lower priority TV is decreased starting with the lowest priority TV. Once the requirement for CRP change is established, the needed actions are applied.

The following represent two logical ways of gathering the requisite PEs:

1. If, after decreasing the CRP value of the lowest priority TV to its minimum value, there are still not enough PEs to provide the performance required by the current TV, then the lowest priority TV is deleted. This is continued until either the required PE count is reached or there are no further lower priority TVs.

2. If, after decreasing the CRP value of the lowest priority TV to its minimum value, there are other TVs with priorities lower than the current requesting TV then the next lowest priority TV reduces its PE count until it reaches its minimum. This is repeated until there are no lower priority TVs left, and the lowest priority TV is deleted.

If there are no further lower priority TVs and the performance requirement of the current TV is still not met, then the Data monitoring TALP generates an error. If the performance requirement of the current TV is met, then the adjusted Emlog becomes a newly created Emlog, identified by the missing TVs, the decreased CRP TVs, and the increased CRP in the current TV. This new Emlog is saved, and the original Emlog is connected to the new Emlog. Control is transferred from the original to this new Emlog. This leads to a rule that defines the most primitive class of machine directed learning.
Rule 8: If the real-time performance requirement of a higher-priority TV can met by decreasing the CRP of lower-priority TVs and/or eliminating lower priority TVs, then a new Emlog can be created.

This new Emlog will be invoked again under the same circumstances and conditions. This is an example of a single-trial learning result of the type used by natural processing systems. This single-trial learning required neither a self-organizing map model, an adaptive resonance theory model, nor a Cerebellar Model Articulation Controller model.

What makes this machine learning rule unique is its emphasis on resource allocation and the trigger for that resource allocation, based on the highest-priority real-time requirements and the physical resources available. Compare this to standard expert system rules that concentrate on symbols and symbol processing or upon modus ponens logic rules. Rule 8 is a real-time performance and resource allocation rule that is invoked whenever the correct flow and processing requirements are met; it is not a symbol detection and processing rule.

### Insufficient Maximum CRP Indicated

When the data rate of an input data stream generates a processing performance requirement that exceeds the performance generated by the maximum possible CRP for the current TVs using the current input attribute values, the current processing TALPs must be changed to those that meet the input attribute list and the data stream's data rate. The system first searches the Emlog database for Emlogs that both match the input attribute list and the data stream's data rate. If Emlog match is found, the system searches the TALP database for TALPs with attributes that match some or all of the input attribute values. The set of found TALPs is used to create a new Emlog. This is the basis of additional single-trail learning methods.
Rule 9: If the current data rate exceeds the maximum possible for the TALPs of an Emlog then the Emlog database is searched for a new Emlog whose input attributes and data rates match the data stream.
Rule 10: If the current set of input streams whose attributes and performance data rates correspond to an existing set of TVs, and there is no existing single Emlog that fully corresponds to the found set of TVs, then that set of TVs is grouped into a new Emlog.

### Automatic Algorithm Creation

The set of attribute values used to generate the prediction polynomial for a data object or data stream represents a pattern which can be saved along with the current external context text string, associated natural-language requirements, and the prediction polynomial, eliminating the need to recalculate the polynomial. For example, if a detected aircraft at some altitude in the past showed a particular change-in-velocity curve as a function of altitude, then its rate of change could be predicted given the same conditions.

The current system 100 uses an inventive automatic multiple-attribute prediction method (Piece-wise Monotonic Polynomial Splines of Different Types) to predict attribute values. This method can be used to not only determine if there is a relationship between any set of attributes but given a relationship, construct a prediction polynomial for that relationship. The generated prediction polynomials are automatically converted to the form of a single pathway of executable code, a TALP. The attribute name, type, rate, range, and description are used to automatically generate a natural-language requirement which is associated with the new TALP. Thus, predictive TALPs can be said to be automatically created without decomposing existing algorithms. Since these automatically created TALPs can be automatically selected from input attributes, then the system 100 can be said to have autonomously learned to predict the behavior of a data object, or data stream without the use of statistics.

### Input Attribute Permutations

In order to determine if there is a relationship between input attributes in a set of attributes, the system must first create all possible permutations of those attributes. For example, if the input dataset attributes are labeled A, B, C, . . . , n then the permutations are:

$$Equation 6 : Attribute Permutation Set$$

$$( X : Y ) = \{ \begin{matrix}( A : B ) , ( A : C ) , ( A : B , C ) , … , ( A : B , C , … , n ) , \\ ( A : B ) , ( A : C ) , ( A : B , C ) , … , ( A : B , C , … , n ) , \\ … \\ ( n : A ) , ( n : B ) , ( n : A , B ) , … , ( n : A , B , … , n - 1 )\end{matrix} \}$$

$$\begin{matrix}Where X = The predicted attribute \\ Y = The set of input variable attributes\end{matrix}$$

### Single-Attribute Time-Based Prediction

The values of many attributes change over time in a way that does not relate to processing time. Given an attribute a, associated with a set of time values t, the values of a can be analyzed to determine how they change over time.

Using the time-complexity polynomials shown for TVs, it is possible to predict a particular time value tₐ_{ₓ} given a particular attribute value aₓ. The time-complexity polynomial used by TVs predicts the processing time of a TALP, while here, it simply relates time to an attribute value.

### Equation 7: Single Attribute Time-Complexity Generation

tₐ_{ₓ}=ℏ(aₓ)=T_{Talp}(aₓ,n)×tu
Where ℏ( )=time-prediction polynomial creation function

It is also now possible to predict a particular single attribute value aₜ_{ₓ} given some particular time value tₓ.

### Equation 8: Single Attribute Inverse Time-Complexity Generation

aₜ_{ₓ}= [symbol] (tₓ)
Where [symbol] =inverse polynomial creation function
   Note that what the predicted attributes represent does not affect the predicted values.

### Single-Attribute Non-Time-Based Prediction

The relationship between some attributes is independent of time. For example, velocity and fuel consumption can be related independent of time. If there is a set of unique non-time-based attribute values A and another set of related, unique, non-time-based attribute values B then substituting A for a and B for t allows the previously defined time-prediction method to be used to predict related attribute values. The following steps are used in this analysis:
1. A set of unique non-time-based attribute values A sorted by the related unique values of non-time-based attribute values B is received.
2. A is substituted for a and B for t then a prediction polynomial is generated.
3. The maximum error value Eₘₐₓ is calculated.
4. The system ensures that Eₘₐₓ≤some operator-given maximum acceptable error value. If so, then the inverse polynomial is generated.
5. The non-time-based predicting polynomial is used to predict values of B given values of A and the inverse non-time predicting polynomial to predict values of A given values of B.

It is now possible to predict a particular single attribute non-time-based value B_{A}_{ₓ} given a particular attribute value A, and vice versa.

### Equation 9: Single-Attribute Non-Time-Based Prediction

B_{A}_{ₓ}=ℏ(Aₓ)

### Equation 10: Single-Attribute Inverse Non-Time-Based Prediction

A_{B}_{ₓ}= [symbol] (Bₓ)

Note that what the predicted attributes represent does not affect the predicted values.

### Multiple-Attribute Time-Based Prediction

As previously taught, it is possible to generate a time-based prediction polynomial given multiple simultaneous time-varying attributes. This is accomplished by varying each attribute separately and calculating a prediction polynomial for each. This set of polynomials represents the partial solution to the prediction problem. Completing the solution requires combining the polynomials by determining the relationships among them. There are a large number of ways that these polynomials can be combined, but below are some of the combining methods.

### Equation 11: Additive/Subtractive Relationships Among Multiple-Attribute Polynomials

R_x=∂ℏ(A_x)±∂ℏ(B_x)± . . . ±∂ℏ(n_x)

### Equation 12: Multiplicative Relationships Among Multiple-Attribute Polynomials

R_x=∂ℏ(A_x)×∂ℏ(B_x)× . . . ×∂ℏ(n_x)

Since a data object can have multiple attributes, the predicted values of two or more attributes can be generated.

$$Equation 13 : Additive / Subtractive Permutation Relationships among Multiple - Attribute Polynomials$$

$$Relationships = \{ \begin{matrix}\partial h ( {A}_{x} ) \pm \partial h ( {B}_{x} ) , \partial h ( {A}_{x} ) \pm \partial h ( {C}_{x} ) , … , \partial h ( {A}_{x} ) \pm \partial h ( {n}_{x} ) , \\ \partial h ( {A}_{x} ) \pm \partial h ( {B}_{x} ) \pm \partial h ( {C}_{x} ) , \partial h ( {A}_{x} ) \pm \partial h ( {C}_{x} ) \pm \partial h ( {D}_{x} ) , … , \partial h ( {A}_{x} ) \pm \partial h ( n - {1}_{x} ) \pm \partial h ( {n}_{x} ) , \\ … \\ \partial h ( {A}_{x} ) \pm \partial h ( {B}_{x} ) \pm ⋯ \pm \partial h ( {n}_{x} )\end{matrix} \}$$

$$Equation 14 : Multiplicative Permutation Relationships among Multiple - Attribute Polynomials$$

$$Relationships = \{ \begin{matrix}\partial h ( {A}_{x} ) \times \partial h ( {B}_{x} ) , \partial h ( {A}_{x} ) \times \partial h ( {C}_{x} ) , … , \partial h ( {A}_{x} ) \times \partial h ( {n}_{x} ) , \\ \partial h ( {A}_{x} ) \times \partial h ( {B}_{x} ) \times \partial h ( {C}_{x} ) , \partial h ( {A}_{x} ) \times \partial h ( {C}_{x} ) \times \partial h ( {D}_{x} ) , … , \partial h ( {A}_{x} ) \times \partial h ( n - {1}_{x} ) \times \partial h ( {n}_{x} ) , \\ … \\ \partial h ( {A}_{x} ) \times \partial h ( {B}_{x} ) \times ⋯ \times \partial h ( {n}_{x} )\end{matrix} \}$$

Like single-attribute time-based prediction polynomials, before any multiple-attribute time-based prediction polynomial is considered acceptable, its prediction error value is calculated and compared against a given acceptable error value. The polynomial whose prediction error value is both less than or equal to the given acceptable error value and is closest to zero is the one selected as the prediction polynomial.

Since the original polynomials always represent a monotonic relationship using the described method, Runge's phenomenon does not occur as there is no oscillation. The lack of oscillation allows greater than fifth-order polynomials to be generated. Monotonicity also means that every polynomial created this way has an inverse.

$$Equation 15 : Inverse Additive / Subtractive Permutation Relationships among Multiple - Attribute Polynomials$$

$$Inverse Relationships = \{ \begin{matrix}\partial ( {A}_{x} ) \pm \partial Å ( {B}_{x} ) , \partial ( {A}_{x} ) \pm \partial ( {C}_{x} ) , … , \partial ( {A}_{x} ) \pm \partial ( {n}_{x} ) , \\ \partial ( {A}_{x} ) \pm \partial ( {B}_{x} ) \pm \partial ( {C}_{x} ) , \partial ( {A}_{x} ) \pm \partial ( {C}_{x} ) \pm \partial ( {D}_{x} ) , … , \partial ( {A}_{x} ) \pm \partial ( n - {1}_{x} ) \pm \partial ( {n}_{x} ) , \\ … \\ \partial ( {A}_{x} ) \pm \partial ( {B}_{x} ) \pm ⋯ \pm \partial ( {n}_{x} )\end{matrix} \}$$

$$Equation 16 : Inverse Multiplication Permutation Relationships among Multiple - Attribute Polynomials$$

$$Inverse Relationships = \{ \begin{matrix}\partial ( {A}_{x} ) \times \partial ( {B}_{x} ) , \partial ( {A}_{x} ) \times \partial ( {C}_{x} ) , … , \partial ( {A}_{x} ) \times \partial ( {n}_{x} ) , \\ \partial ( {A}_{x} ) \times \partial ( {B}_{x} ) \times \partial ( {C}_{x} ) , \partial ( {A}_{x} ) \times \partial ( {C}_{x} ) \times \partial ( {D}_{x} ) , … , \partial ( {A}_{x} ) \times \partial ( n - {1}_{x} ) \times \partial ( {n}_{x} ) , \\ … \\ \partial ( {A}_{x} ) \times \partial ( {B}_{x} ) \times ⋯ \times \partial ( {n}_{x} )\end{matrix} \}$$

Note that multiple-attribute non-time-based prediction works analogously to single-attribute non-time-based prediction. Instead of substituting B for t, giving, Bₐ_{ₓ} each of the multiple-attributes is substituted for t, giving {Bₐ_{ₓ}, B_{b}_{ₓ}, . . . , Bₙ_{ₓ}}. After all substitutions are made, the various multiple-attribute prediction polynomials are checked to determine the polynomial with the smallest error margin, which is selected.

### Looped Emlogs

Given a data object periodically detected over time, if there is a single Emlog associated with it and some or all of the data object attribute values vary, then a time loop for an Emlog has been detected.

### Equation 17: Simple Looped Emlog Definition

Rₓ=Σᵢ₌₁^{period count}Eᵢ
Where Rₓ=Processed output values for the x^{th} Emlog
   Eᵢ=i^{th} Emlog iteration

A time period can itself be associated with an attribute that varies with time, creating nested loops.

### Equation 18: Simple Nested Loop Emlog Definition

Rₓ=Σⱼ₌₁^{periods count}Σᵢ₌₁^{period of periods count}E_{i,j}

Many other looping possibilities exist. Because there can be loops with associated detection periods, it is possible for the predictive TALPs associated with a looped Emlog to be parallelized and managed like any other TALP.

Machine Learning from Predictive Polynomials.

The ability to generate predictive polynomials and their inverses, automatically select the best predicting polynomial, and automatically detect when to apply that predicting polynomial leads to the following machine learning rule.
Rule 11: Given any set of data attributes where there is at least one predictive polynomial, or predictive inverse polynomial, whose prediction error value is less than or equal to some predefined error margin, that predictive polynomial is considered a learned TALP after conversion to executable form.
   Operator-Assisted Programming from Emlog Chains

It is possible for multiple Emlogs to be active in the system simultaneously and in communication as long as there is only one head Emlog and at least one tail Emlog per chain of Emlogs. A chain of Emlogs is a set of Emlogs whose inputs and outputs are connected. A head Emlog receives its data from sensors, operators, or files but not directly from the output of another Emlog. A tail Emlog receives its data directly from the output of another Emlog but never from a sensor, operator, or file. This means that one tail Emlog can communicate to another tail Emlog and the head Emlog can communicate to a tail Emlog, but a tail Emlog cannot communicate to a head Emlog. In order for one Emlog to follow another Emlog, some or all of the output attribute values of the leading Emlog must match the input values of the trailing Emlog, which means that both the output attribute data types and the output attribute data ranges match.

Since a subset of the output attributes might be sufficient, different output attribute subsets can be used to communicate to different potential tail Emlogs, allowing for multiple processing options. An operator specifies a starting goal/requirement such as taking multiple images of an area. Receiving this specification, the system 100 identifies Emlogs that could perform the action. The operator then specifies an ending goal/requirement such as merging all images. The system 100 then identifies Emlogs that could fulfill this request. For example, as soon as an image is taken, an attempt could be made by the system to merge the new image directly with any subsequent images, or the system might take the image, orthorectify it, and then merge that image with any subsequent orthorectified images. In order to limit the software knowledge required of the operator, all possible processing options between taking multiple images and merging them are tried by the system 100, and those results are displayed to the operator. The operator then selects the desired processing option from the displayed results. This selected processing option becomes the Emlog chain, with one head and one tail Emlog. The operator can give additional requirements that add Emlog links to the current Emlog chain.

The operator only needs to know what they want to accomplish and the system 100 generates the alternatives to allow the operator to obtain the best result without the necessity of programming or overly specifying the results. This is equivalent to the system 100 writing multiple computer programs, offering alternative results, and remembering the program that created the most desired alternative result for future reference.

Referring to the diagram 162 of FIG. 26, given a head Emlog (H) with inputs a₁, a₂, and a₃ with outputs of b₁ and b₂ and a tail Emlog (T) with inputs attributes b₁ and b₂ whose data ranges are compatible with H and has ci output data attributes, the output of H is the input of T so the two Emlogs can be connected, with both active simultaneously.

Referring to the diagram 164 of FIG. 27, another head Emlog H₁ that can receive the input dataset (or a subset thereof) that produces output attributes that are also compatible with the input attributes of T represents an additional pathway. Given another tail Emlog T₁ whose input attributes are compatible with the output of H and whose output attributes are compatible with T, H can connect to T₁ and T₁ can connect to T creating another Emlog pathway.

Any number of tail Emlogs can be placed between H and T as long as the input and output attributes are compatible. An operator can select the desired Emlog from the generated chains which would be automatically placed after the last tail of the current Emlog chain. An Emlog chain is depicted in diagram 166 of FIG. 28.
Rule 12 Given a set of system-identified Emlog chains whose output attribute types and values of their final tails match the input types and values of the head Emlog of the current Emlog chain, an operator selection of the desired Emlog chain from that set of Emlog chains causes the system to convert the head of the current Emlog chain to a tail Emlog and attaches that tail to the final tail of the selected Emlog chain, creating a new Emlog chain.
Rule 13: Given a set of system-identified Emlog chains whose input attribute types and values of its heads match the output types and values of the tail Emlog of the current Emlog chain, an operator selection of the desired Emlog chain from that set of Emlog chains causes the system to convert the head of the selected Emlog chain to a tail Emlog and attaches that tail to the final tail of the current Emlog chain, creating a new Emlog chain.
   System-Directed Programming from Emlog Chains

One of the hallmarks of natural compute systems is their ability to extend their capability using self-programming. True self-programming has been a primary objective of AI since its inception. Programs in this system 100 consist of Emlog chains which are composed of Emlogs, which are in turn composed of TALP Vectors (TVs). It has been shown that it is possible to create TALPs from generated prediction polynomials and that TVs are associated with TALPs. A primitive Emlog chain is a single Emlog that is both a head and a final tail. Any Emlog chain can be expanded by either linking existing Emlogs to the chain or synthesizing new Emlogs that are linked to the chain. Since Emlogs are the same regardless of their origin, the rules for attaching Emlogs before the head Emlog or after the final tail Emlog are the same. Below are two Emlog synthesis methods for Emlog attachment to an Emlog chain: pre-head Emlog synthesis and post-final-tail Emlog synthesis.

### Pre-Head Emlog Synthesis

Given a head Emlog in an Emlog chain generating some output values, given some input values, it is possible to automatically synthesize an Emlog that occurs before the current head Emlog. Since the head Emlog receives a set of input attribute types and values as well as the input attribute data rate and since there is a database of all known TALPs/TVs and their input/output attributes, value ranges, and time-prediction polynomials, it is possible to list all TVs whose outputs are compatible with the head Emlog's input attribute types, values, and data rates. Consider that Emlogs can be synthesized by linking together TVs whose combined outputs match the head Emlog's input attributes. Using the inverse multiple-attribute non-time-based prediction method with the list of TVs whose combined outputs match the head Emlog's input attributes, it is possible to generate the input values of the associated TVs. TVs of the head Emlog have minimum and maximum acceptable data rates. The inverse of these data rates gives the minimum and maximum values of the multiple-attribute time-based values. Combining the multiple time-based and non-time-based attribute values gives the data ranges of the combined TVs. Any set of TVs whose combined outputs match the inputs of the head Emlog but whose attribute range or timing does not match the requirements of the head Emlog are eliminated. It is now possible to synthesize one or more Emlogs that meet the requirements of the head Emlog and can occur before the current head Emlog.
Rule 14: Given a current head Emlog with a valid set of Emlog attribute values, an Emlog can be automatically attached prior to that head Emlog. By converting the current head Emlog to a tail Emlog and the to-be-attached Emlog to a new head Emlog, the new head Emlog is appended to the current Emlog chain, generating a new Emlog chain.

### Post-Final-Tail Emlog Synthesis

Given a final tail Emlog in an Emlog chain generating some output values, given some input values, it is possible to automatically synthesize an Emlog occurring after the current Emlog's final tail. Since the final tail Emlog generates a set of output attribute types and values and has an associated time-prediction polynomial, and since there is a database of all known TALP/TVs with their input/output attributes, value ranges, and time-prediction polynomials, it is possible to list all TVs whose inputs are compatible with the final tail Emlog's output attribute types, values, and processing times. Consider that Emlogs can be synthesized by linking together one or more sets of TVs whose aggregate inputs match the final tail Emlog's output attribute types, values, and data processing rates. Any set of TVs whose combined inputs match the outputs of the head Emlog but whose attribute range or timing does not match the requirements of the final tail Emlog are eliminated. It is now possible to synthesize one or more Emlogs that meet the requirements of the final tail Emlog and can occur after the final tail Emlog of the current Emlog chain.
Rule 15: Given a current final tail Emlog, an Emlog can be attached to the current final tail, becoming a new final tail Emlog and generating a new Emlog chain.

### System-Directed Temporary Emlog Chain-to-Chain Connections to Reach Goals

Any Emlog chain can be associated with a goal or requirement. Natural systems frequently need to determine if a goal can be met from any particular starting point. Can the goal be met, and if so, how long will it take to meet that goal? To add complexity to the problem, the detected data may not directly address the input data required by the goal. The system 100 needs to transform the detected data so that it matches the input data required to reach the goal. For example, given a goal to count the number of elk in a large area using networked drones that can each detect any animal in its immediate area, the data that represents detected animals per drone must be filtered to fit the input criteria of the goal. The goal Emlog chain counts the number of elk and requires as input the images of detected elk per drone. Because the drones detect all animals, not just elk, the detected data does not match the goal Emlog chain's input requirements. A different Emlog chain that removes any non-elk image is temporarily linked to the goal Emlog chain, creating a chain-to-chain connection.

Since an Emlog chain can be connected to another Emlog chain, the system 100 can set up a series of temporary Emlog chain-to-chain connections from the starting point to the given goal. Because the minimum and maximum processing time of each Emlog chain is known from the time-prediction polynomials attached to the associated TVs of each Emlog in the Emlog chain, the system 100 can automatically calculate a minimum and maximum processing time for each chain-to-chain connection. The system 100 analyzes the various temporary Emlog chain-to-chain connections in terms of time. The Emlog chain-to-chain connection that takes the least amount of processing time is automatically selected. Neither the number of Emlogs in a chain nor the number of Emlog chains connected is relevant, as depicted in FIG. 28.
Rule 16: Generating a set of temporary Emlog chain-to-chain connections between the current starting point and the goal-associated Emlog chain allows the system to select the fastest chain-to-chain connection to both reach the goal and determine when the goal will be reached.

If there is no Emlog chain-to-chain connection that links the current input data to the goal Emlog chain within the timing requirements, it may be possible to synthesize Emlog chain-to-chain connection that would do so using the methods described in System-Directed Programming from Emlog Chains section detailed herein.
Rule 17: Extending an Emlog chain-to-chain connection from the current starting point to the goal-associated Emlog chain enables the system to self-modify in order to reach a goal.
   Machine Determination from Monitoring TALP Priority

In natural systems, the amount of effort expended to achieve a goal can be called determination. Synthesizing Emlogs and creating temporary Emlog chain-to-chain connections takes a great deal of effort in terms of processing time and compute resources. Performing these activities for all goals, even low-priority ones, can slow overall system performance. An alternative is to limit the goals for which these synthesizing and chain-to-chain activities are used or limit the amount of processing time and/or number of compute resources to be used by the system 100 to meet goals.

### Emlog Chain Interrupt Handling

In this system 100, as in natural systems, higher-priority goals can suspend or end an existing goal and/or the processing steps used to achieve that lower-priority goal. The priority of a goal is the priority of its underlying Emlog chain. The priority of an Emlog chain is determined in one of two ways. If an Emlog chain is invoked because its head Emlog's Trigger TALP receives all required data, then the priority of the Emlog chain is the highest-priority non-monitoring (processing) TALP within the invoked head Emlog. If an Emlog chain is invoked because its head Emlog Trigger signals a Distress, Intersystem Communication, or Context monitoring TALP then its priority is the priority of that monitoring TALP.

Before a monitoring TALP invokes an Emlog chain, it first invokes the Pushdown TALP which saves the current input data, the currently active processing TALPs, the current Emlog designation, and the current Emlog chain designation. This is the system's equivalent of an interrupt handler. All monitoring TALPs of the newly invoked Emlog chain are quiesced in order to not interfere with the current monitor activity. The monitoring TALPs of the Emlog that is invoking another Emlog chain because of a monitored condition are still active. If one of these active monitoring TALPs detects a condition requiring the activation of another Emlog chain, that TALP's priority is compared to the currently triggered monitoring TALP's priority. If the new priority is greater than the previous priority, all of the previously activated Emlog chain's information is pushed down onto the stack, and the new monitoring TALP activates a new Emlog chain. Once the conditions for invoking the currently active monitoring TALP's Emlog chain no longer exist then the first monitor-activated Emlog chain is re-activated by using the Popup TALP to recover its information. Similarly, once the conditions for invoking the first monitor-activated Emlog chain no longer exist, then the original Emlog chain is re-activated. It should be noted that the processing of an Emlog or Emlog chain ceases when there is no additional. There is no inherent limit to the number of stackable interrupts.

While various embodiments have been described above, it should be understood that they have been presented by way of example only, and not limitation. Thus, the breadth and scope of the present disclosure should not be limited by any of the above-described embodiments or examples. Moreover, any combination of the above-described elements in all possible variations thereof is encompassed by the disclosure unless otherwise indicated herein or otherwise clearly contradicted by context.

References to methods and steps such as inputting, entering, and the like can include manual user inputs, or direct generation and insertion/inclusion of data via software.

Additionally, while the methods described above and illustrated in the drawings are shown as a sequence of steps or processes, this was done solely for the sake of illustration. Accordingly, it is contemplated that some steps may be added, some steps may be omitted, the order of steps may be re-arranged, and some steps may be performed in parallel.

It will be readily apparent to those of ordinary skill in the art that many modifications and equivalent arrangements and methodologies can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of Section 112, sixth paragraph of 35 U.S.C. are not to be invoked unless the specific terms “means for” or “step for” are recited in a claim.

1. A method of artificial intelligence (AI) computing, comprising:
receiving internal context data via one or more natural-language inputs to define one or more device physical characteristics;
receiving external context data to define external environment characteristics;
receiving one or more goals from an operator input;
generating one or more native commands configured for use by one or more devices; and
creating executable time-affecting linear pathways (TALPs) to create one or more composite commands associated with the one or more goals.

2. The method of claim 1, further including automatically composing commands for the one or more devices from the natural-language inputs.

3. The method of claim 1, further including associating one or more natural-language statements with one or more stored composed commands using a combination of one or more search misses and one or more search hits.

4. The method of claim 1, further including generating one or more time-prediction polynomials or inverse time-prediction polynomials for the TALPs.

5. The method of claim 4, further including using the time-prediction polynomials or the inverse time-prediction polynomials to construct one or more TALP vectors (TVs).

6. The method of claim 1, further including constructing one or more TVs and selecting a correct number of processing elements to use based on one or more received real-time requirements and the one or more TVs.

7. The method of claim 1, further including receiving one or more real-time requirements and automatically selecting one or more processing elements to facilitate processing of the one or more real-time requirements.

8. The method of claim 1, further including storing the one or more TALPs and respective value ranges for later use.

9. The method of claim 8, further including automatically selecting one or more of the one or more stored TALPS based on one or more received input datasets.

10. The method of claim 1, further including monitoring and reacting to one or more external conditions independent of compute processing being performed.

11. The method of claim 1, further including creating one or more emotion analogs (Emlogs) to predict behavior of one or more objects.

12. The method of claim 11, wherein the one or more Emlogs are chained.

13. The method of claim 11, further including transmitting the one or more Emlogs or the one or more TALPs via an ad hoc network.

14. The method of claim 11, further including displaying to the operator real-time processing and results of processing pathways of the one or more Emlogs.

15. The method of claim 14, further including selecting by the operator the displayed results for future processing requests.

16. A method of artificial intelligence (AI) computing, comprising:
receiving internal context data via one or more natural-language inputs to define one or more device physical characteristics;
receiving external context data defining one or more external environment characteristics;
receiving one or more goals via an operator input;
generating one or more native commands configured for use by one or more devices;
creating one or more executable time-affecting linear pathways (TALPs) to construct one or more composite commands associated with the one or more goals; and
creating one or more emotion analogs (Emlogs) associated with the one or more TALPs to predict behavior of one or more data objects.

17. The method of claim 16, further including generating one or more non-time-prediction polynomials and one or more inverse time-prediction polynomials to predict behavior of the one or more data objects.

18. The method of claim 16, further including using one or more time-prediction polynomials or one or more inverse time-prediction polynomials to construct one or more TALP vectors (TVs).

19. The method of claim 16, wherein the one or more Emlogs are chained.

20. A method of artificial intelligence (AI) computing, comprising:
receiving data attribute streams while in an external context to automatically select time-affecting linear pathways (TALPs) and to automatically determine real-time processing requirements; and
automatically selecting one or more emotion analogs (Emlogs) based on the data attribute streams.
